(19) United States
(12) Patent Application Publication
(10) Pub. No.: US 2009/0050559 A1
(43) Pub. Date: Feb. 26, 2009

(54) Bottle with a Flow-impeding Device for Dispensing of Non-Uniform Liquids

(76) Inventor: Melvyn Rosenberg-Nevo, Ramat Gan (IL)

Correspondence Address: The Law Office of Michael E. Kondoudis, PC, 888 16th Street, N.W., Suite 800, Washington, DC, 20006, US

(21) Appl. No.: 12/194,059

(22) Filed: Aug. 19, 2008

Related U.S. Application Data
(60) Provisional application No. 60/935,572, filed on Aug. 20, 2007.

(51) Int. Cl. B01D 12/00

(52) U.S. Cl. 210/514

(57) ABSTRACT

A bottle for containing and dispensing of a non-uniform liquid comprising a lower-phase and an upper-phase where the lower-phase is a liquid of a higher specific-weight than the upper-phase. The bottle may comprise a flow-impeding device, where the flow-impeding device impedes the flow of the liquid that is dispensed from the bottle to allow impeding the dispensing of the uppermost layer, which may be the upper-phase layer from said bottle.

### CROSS REFERENCE TO RELATED APPLICATION

This application claims the benefit of U.S. Provisional Patent Application 60/935,572, filed Aug. 20, 2007, which is incorporated herein by reference in its entirety.

### FIELD OF THE INVENTION

The present invention relates to the field of bottles for containing and dispensing of liquids and more particularly, to bottles for containing and dispensing of non-uniform liquids.

### BACKGROUND OF THE INVENTION

Currently, mouthwash bottles, as most other bottles for dispensing of liquids, have an aperture area, which is either equal or slightly smaller than the opening area of the edge part of the bottle that meets the aperture. This is mostly sufficient for dispensing liquids of a uniform phase. However, in the case of a two-phase mixture such as a two-phase mouthwash, which is a combined mouthwash for oral hygiene that is composed of two liquids of unequal specific-weight and viscosity, where one phase floats above the heavier phase—a too-large aperture may cause the upper-phase to escape too quickly when the bottle is near full leaving a smaller amount of the upper-phase for the next pour and so forth—until the proportions of the phases of the poured liquid are reversed, leaving hardly any of the upper-phase when the bottle is half full or near empty.

To use the two-phase liquid such as the two-phase mouthwash, which contains a two-phase mixture of oil and watery solution, for example, one mixes the phases (e.g. by shaking of the bottle), creating a temporary emulsion. Then the cap is removed and the liquid poured into a cap (e.g. the cap of the bottle). During the time elapsed (while the cap is removed and the bottle is turned over by the user for the pouring), the phases start to separate so that there is a top layer that is rich in oil and poor in water. Even if the cap is removed quickly, the hand mixing procedure usually results in a temporary emulsion that starts to separate right after mixing within a short period of time following the mixing (e.g. less than one second). This is particularly the case when the bottle is full, which makes the mixing more difficult.

The result is that when the bottle is full, the initial dispensing yields an oil-rich and water-poor mixture. When the consumption of the contents of the bottle is towards the end, the ratio reverses. In the case of the two-phase mouthwash the ratio of aqueous:oil phase is about 85:15 w/w, this means that at the beginning of use, the user may dispense a disproportionately large portion of the oil phase when the bottle is full or near full, resulting in less-than-desirable taste and function, which repeats itself in reverse when most of the contents of the bottle have been consumed, and the oil:aqueous ratio is lower than intended. It is the purpose of the Invention therefore to ensure a more proportionate delivery of the mixture.

### SUMMARY OF THE INVENTION

The present invention, according to non-limiting embodiments thereof, provides a bottle for containing and dispensing of a non-uniform liquid such as a two-phase mouth wash, for instance.

The liquid may comprise two phases: a lower-phase and an upper-phase where the lower-phase is a liquid of a higher specific-weight than that of the upper-phase, which enables the upper-phase to naturally form above the top one.

According to some embodiments of the invention, the bottle may comprise a flow-impeding device, where the flow-impeding device impedes the flow of the liquid that is dispensed from the bottle to allow impeding the dispensing of an uppermost layer of the liquid such as at least a portion of the upper-phase.

The user may be required to mix the phases before pouring the liquid into a cap, to create a temporary emulsion of the two liquids, in which case the upper-phase may start reforming immediately after the mixing. The flow-impeding device may be used to impede the dispensing of the reforming upper-phase.

According to some embodiments of the invention, the bottle may comprise a body, which is the lower part of the bottle; a neck integrally connected to said body located above the body, wherein the top edge of said neck defines an opening of the bottle having a predefined circumference; and a flow-impeding device connected to said opening along the circumference of the neck.

According to some embodiments of the invention, the flow-impeding device comprises at least one protruding sealing member creating at least one reduced opening, wherein each protruding sealing member is a curved structure creating at least one cavity therein, enabling to receive the liquids from within the bottle.

The protruding sealing member may enable delaying the dispensing of the upper-phase when the bottle is positioned in a pouring tilted position (e.g. when the bottle is tilted and the protruding sealing member is situated above the reduced opening), by sealing at least part of the bottle's opening and by enabling at least part of the upper-phase to be contained by said cavity.

The liquid in the bottle may be dispensed into any suitable cap known in the art, such as for example a cup like structure that can also serve as the bottle's lid.

The body may have a trimmed conical shape having a bottom-base, which is wider than the top-base, wherein the circumference of the lower edge of the neck is equal to the circumference of the upper edge of the body.

According to some embodiments of the invention, the flow-impeding device may comprise two protruding sealing members connected to one another to create the reduced opening, where the reduced opening is mouth-shaped.

According to some embodiments of the invention, the bottle may further comprise a protruding ring, which is a circular protruding structure creating a ring cavity therein, wherein said ring integrally connects the upper edge of the body to the lower edge of the neck.

According to some embodiments of the invention, at least one of the protruding sealing members may comprise at least one hole enabling to enhance the flow rate of the liquid when it is dispensed by allowing air to enter the bottle while the exiting liquid dispensed therefrom, which may seal the reduced opening.

According to some embodiments of the invention, at least one of the protruding sealing members may additionally or alternatively comprise at least one indicator thereon, which enables indicating the right positioning of the sealing member when used for dispensing of said liquid. For example, the indicator may be an arrow sign indicating that the sealing member upon which it is positioned should be held upwardly when tilted to a pouring position—so that this indicated sealing member would be situated above the reduced opening when the user dispenses the liquid from the bottle.

According to other embodiments of the invention, the protruding sealing member may be a half sphere situated at the center of the bottle's opening separated from the circumference of the neck and connected thereto by securing means, creating reduced openings situated along a ring encircling the protruding sealing member.

According to some embodiments of the invention, the bottle's body may include at least one right-angled corner at the lower part of the bottle, where that corner is constructed from two crossing walls of the body and the body's base, where the walls are perpendicular to one another and to the base.

According to alternative embodiments of the invention, the bottle for containing and dispensing of a two-phase liquid may comprise a body, which is the lower part of the bottle; a neck integrally connected to said body located above the body, wherein the top edge of said neck defines an opening of the bottle having a predefined circumference; and at least one separate flow-impeding device inserted into said bottle. The separate flow-impeding device may be a piece that is separated from the bottle, where said separate flow-impeding device is of shape and dimensions that enable the neck opening to block the separate flow-impeding device from exiting the bottle, thereby enabling it to reduce the area of the bottle's opening and therefore to facilitate in impeding the dispensing of the upper-phase.

According to these alternative embodiments of the invention, the separate flow-impeding device enables changing of its dimensions to allow contracting when inserted into the bottle through the neck and retracting once inside the bottle.

The separate flow-impeding device may be made from any elastic material enabling it to change its dimensions according to pressure applied thereon such as, for example, rubber, elastic polymer-based materials and the like.

According to some embodiments of the invention, the separate flow-impeding device may be a ball like shape with retractable protrusions and niches, where the protrusions enable entering the niches once pushed through the neck and retracting back to an open protruding position once inside the bottle.

The specific-weight of the flow-impeding device may be either higher than that of the upper-phase and smaller than that of the lower-phase, allowing it to float between the two phases once the bottle opening faces upwards, or smaller than that of the upper-phase allowing it to float above both phases.

Additionally or alternatively, the separate impeding device that is inserted into the bottle may facilitate in dispersing of the two-phases and creating a substantially homogeneous emulsion of the two-phases once the liquid in the bottle is mixed.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a schematic illustration of a commonly used bottle containing a two-phase liquid;

FIG. 2 is a schematic illustration of a commonly used bottle containing a two-phase liquid in a pouring position;

FIG. 3 is a schematic illustration of a commonly used symmetric bottle containing a two-phase liquid in a different pouring position.

FIG. 4 is a schematic illustration of a bottle containing a two-phase liquid with a flow-impeding device, according to some embodiments of the invention;

FIG. 5 is a schematic illustration of a bottle containing a two-phase liquid with a flow-impeding device at a pouring position, according to some embodiments of the invention;.

FIG. 6 is a schematic illustration of a top view of a flow-impeding device connected to a bottle, according to some embodiments of the invention;

FIG. 7 is a schematic illustration of a top view of a flow-impeding device connected to a bottle, according to additional embodiments of the invention;

FIG. 8A and FIG. 8B are schematic illustrations of a top and a side view respectively, of a bottle containing a two-phase liquid with a flow-impeding device, according to other embodiments of the invention;

FIG. 9 is a schematic illustration of a straight angular two-phase liquid bottle, according to some embodiments of the invention;

FIG. 10 is a schematic illustration of a side view of a bottle containing a two-phase liquid with a straight-angular body in a pouring position, according to some embodiments of the invention;

FIG. 11 is a schematic illustration of a side view of a bottle containing a two-phase liquid with a retractable-separated flow-impeding device, according to some embodiments of the invention;

FIG. 12A and FIG. 12B are schematic illustrations of a retractable separate flow-impeding device in an un-contracted state and in a contracted state respectively, according to some embodiments of the invention; and

FIG. 13 is a schematic illustration of a side view of a bottle containing a two-phase liquid with a separate flow-impeding device, according to other embodiments of the invention.

The drawings together with the description make apparent to those skilled in the art how the invention may be embodied in practice.

### DETAILED DESCRIPTIONS OF SOME EMBODIMENTS OF THE INVENTION

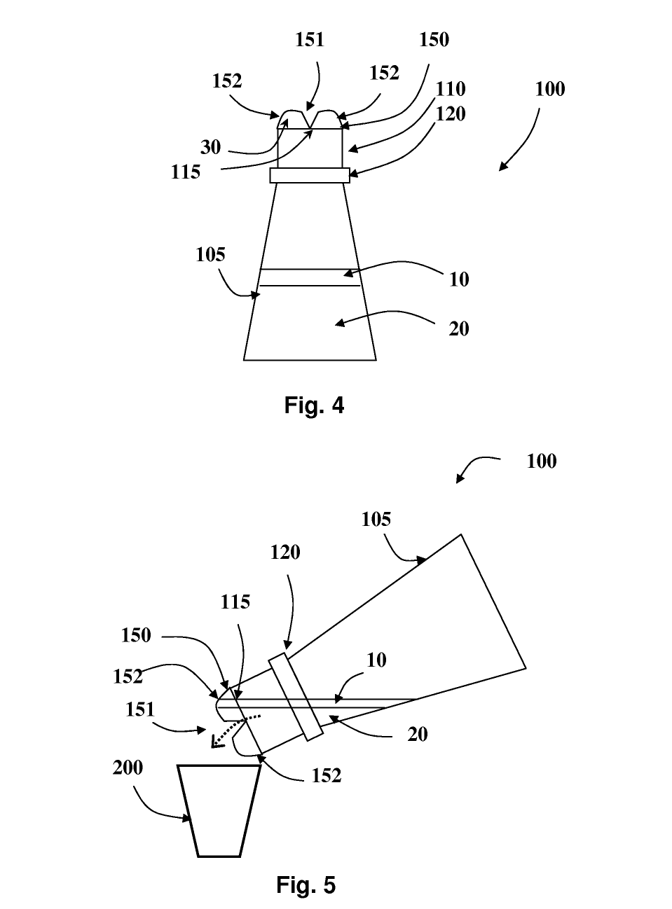

The present invention, in some embodiments thereof, provides a flow-impeding device 150, which may be jointly configured with a bottle 100 or a separate piece, where the bottle 100 may contain a non-uniform liquid having two phases, where the upper-phase 10 of the liquid is of a lower specific-weigh than that of the lower-phase 20. For example, the upper-phase 10 may be a liquid made from an oily substance and the lower-phase 20 of a watery solution, as illustrated in FIG. 4.

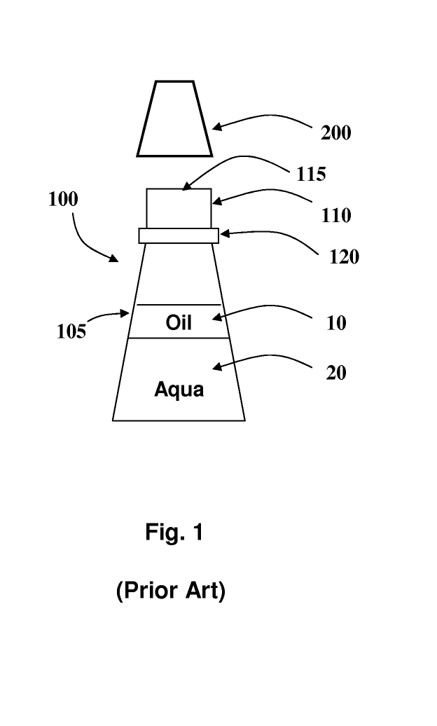

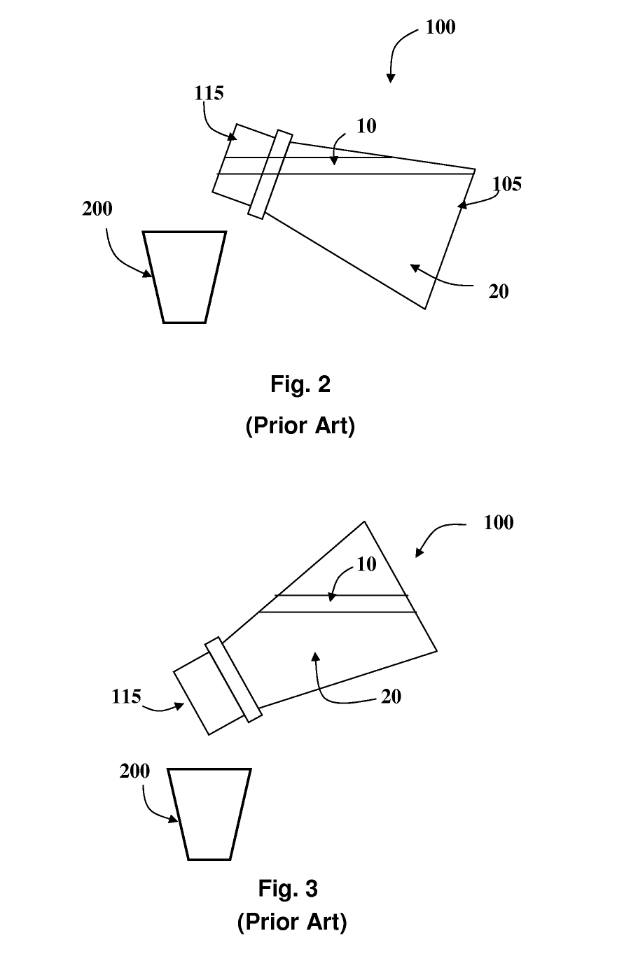

FIG. 1, FIG. 2 and FIG. 3 schematically illustrate a commonly used bottle 100 that comprises a body 105 a protruding ring 120 and a neck 110 that is narrower than the body 105, where the body 105, the ring 120 and the neck 110 are jointly configured to create the bottle 100 and may be molded as a single piece at the production process.

The protruding ring 120 may create a cavity along the circumference of the upper part of the body 105 and the lower part of the neck 110 connecting them to one another.

The upper circumference 115 of the bottle 100 may define an opening of the bottle 100. The bottle 100 may be sealed by a cap, which may also serve as the cap 200 of the liquid poured from the bottle 100 therein.

In this configuration, which is commonly used in the art, the initial dispensing of the two-phase liquid into the cap 200 yields a mixture which is rich in liquid of the upper-phase 10 (e.g. oil) and poor in liquid of the lower-phase 20, where “poor” and “rich” relates to an exceeding ratio between the two phases 10 and 20, where commonly the upper-phase 10 dispensed volume should be much smaller than the volume of the dispensed bottom phase 20. When the contents of the bottle is almost fully consumed or dispensed, the ratio reverses, since very little if any of the upper-phase 10 liquid remains in the bottle 100.

As illustrated in FIG. 2, at a first pouring position in which, for example, the upper-phase 10 and the lower-phase 20 may both reach the opening of the bottle 100, depending upon the volumes and volume ratios of the liquids in the bottle 100 and the shape and volume of the bottle 100 and opening.

Enlarging the pouring angle into a second pouring position as illustrated in FIG. 3, may facilitate in allowing the upper-phase 10 to naturally float upwards without reaching the bottle's 100 opening. Unfortunately, the pouring-angle depends upon the hand-movements of the user, which are hard to predict.

Narrowing of the bottle's 100 opening aperture circumference 115 using a flow-impeding device may facilitate in (a) allowing the natural floating feature of the upper-phase 10 to prevent it from over-spilling; and (b) facilitating in forcing or encouraging the user to enlarge the tilting angle of the bottle 100 in a pouring position to prevent the upper-phase 10 from reaching the opening or at least reduce the volume of the uppermost layer (e.g. a portion of a reformed upper-phase that has reformed after the mixing has been carried out) that reaches said reduced opening 151.

When the liquid is shaken and mixed and becomes an emulsion, right before pouring, the upper-phase 10 reforms to some extent right after mixing. In that case, the bottom layer is the emulsion, which is a temporary mixture of the top and bottom phases 10 and 20, where the uppermost layer contains a lower portion of the upper-phase 10. The flow-impeding device 150 allows impeding the dispensing of that reformed upper-phase 10 and thereby facilitates in keeping the proportions between the top and bottom phases 10 and 20 substantially equal to their initial lower/upper phases-ratios throughout the use of the liquid in the bottle 100.

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

FIG. 4 and FIG. 5 schematically illustrate a bottle 100 for containing and pouring of a non-uniform two-phase liquid comprising an upper-phase 10 and a lower-phase 20 liquids, where the upper-phase 10 is lighter (having a lower specific weight) than the lower-phase 20, according to some embodiments of the invention.

According to some embodiments of the invention, the non-uniform liquid may be a two-phase mouthwash containing substances that can be used for mouthwash, where each phase may have a different function in desorbing bacteria in a user's oral tissue for mouth hygiene, such as the two phase liquids described in a U.S. Pat. No. 6,465,521, which is incorporated by reference herein in its entirety.

According to these embodiments, as illustrated in 4 and FIG. 5, the bottle 100 may comprise:
a body 105, which may have a trimmed conical shape having a bottom-base which is wider than the top-base;
a neck 110, which may be equal in diameter to the top-base of the body 105, where the top edge of the neck creates an opening with a predefined circumference 115;
a protruding ring 120, which may encircle the bottom part of the neck 110 connecting it to the body 105, creating an enlarged cavity area encircling the connecting area between the neck 110 and the body 105; and
a flow-impeding device 150 connected to the top edge of the neck 110 along the circumference 115 comprising at least one protruding sealing member 152, which may be curved structures creating at least one cavity 30 therein, where the member(s) 152 create a reduced opening 151, where each sealing member may be a curved structure creating at least one cavity 30 therein.

The protruding sealing-members 152 may be jointly configured with the bottle 100, and may integrally connect to the top edge of the neck 110 along its upper circumference 115. Additionally, the protruding sealing-members 152 may connect to one another to create the reduced opening 151, where the area of the reduced opening 151 is smaller than the area of the original opening created by the neck's 110 circumference 115.

Once the protruding sealing member 152 is positioned upwards in a pouring tilted position, as illustrated in FIG. 5, the lighter upper-phase liquid 10 may be delayed, since some of it may be caught in the cavity 30 of the upper protruding member 152. The reduced opening 151 may delay the exit of the entire liquid, by slowing down the pouring flow rate; therefore allow a portion of the upper-phase 10 to exit the bottle 100 only once enough of the lower-phase 20 is already dispensed.

Additionally, a lower protruding sealing member 152 may allow further impeding the exit of the heavier lower-phase liquid 20 to prevent it from pouring too fast ending up with an exceeding portion of the lower-phase 20 at the cap 200. Since the quantity (e.g. in volume units) of the upper-phase 10 may be smaller than the quantity of the lower-phase liquid 20 when the bottle 100 is full and unused, the additional delaying of the lower-phase liquid's 20 exiting may be desirable.

Additionally, the user may be required to shake the bottle 100 before pouring so as to create the emulsion mixture of the two phases where only a fraction of the upper-phase 10 reforms on the upper layer above the emulsion. The dispensing of the remaining upper-phase 10 may be delayed or even prevented by the upper protruding sealing member 152 thereby ensuring the dispensing of a liquid comprising mostly or only the emulsion, which contains the right pre-calculated recommended ratio between the two phases 10 and 20.

Additionally, once the flow-impeding device 150 delays or blocks some of the upper-phase 10 from exiting through the reduced opening 151 (depending on the pouring angle at which the bottle is tilted for the dispensing of the liquid), the upper-phase's 10 impact against the inner walls of the flow-impeding device 150, when tilting the bottle 100, may further facilitate in throwing the upper-phase 10 backwards away from the reduced opening 151, thereby further enhance the delaying effect.

The design of the protruding sealing-members 152 may also enhance the delay effect, since the cavity 30 or cavities 30 created by the protrusions may allow a containing space in which the liquid can linger during the pouring time interval.

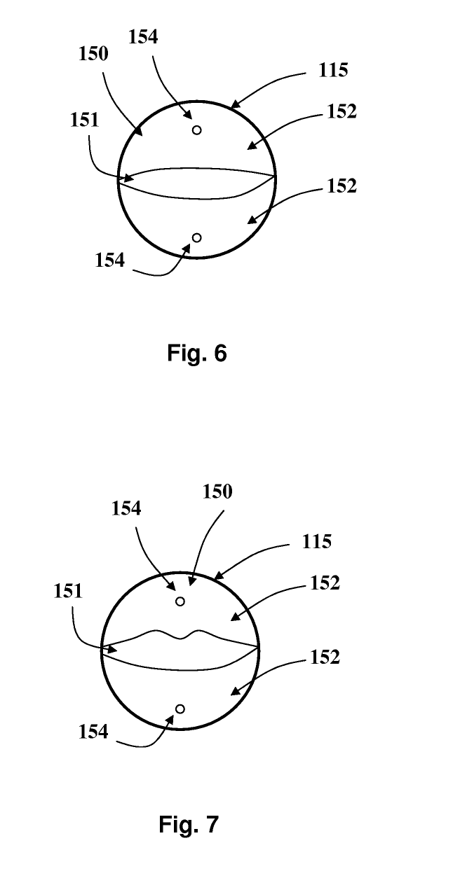

FIG. 6 and FIG. 7 schematically illustrate top views of two possible designs for the flow-impeding device 150, according to embodiments of the invention. The flow-impeding device 150 may be created by two protruding sealing-members 152 that are connected in a configuration that creates the reduced opening 151 with a mouth-like shape, as illustrated in FIG. 7, or any other shape e.g. as illustrated in FIG. 6.

Each sealing-member 152 may additionally include at least one small hole 154, to slightly enhance the flow rate of the liquids from the bottle 100, so that the pouring of the liquid will not become too slow due to the reducing of the bottle's 100 opening.

As known in the art, allowing more air pressure from outside the bottle 100 to enter the bottle 100 may facilitate in accelerating the exit of the liquid from the bottle 100. The two competing effects' (delaying and acceleration) elements may be designed to allow an easy and comfortable pouring while keeping the phases ratios when dispensing the liquid as desirable as possible throughout the usage of the liquid.

Additionally, as illustrated in FIG. 6, at least one of the protruding sealing members 152 may further comprise an indicator 158 marked (e.g. curved thereon, printed thereon and the like) on the outer surface of the protruding sealing member 152. The indicator 158 may indicate the right way(s) of holding the bottle 100 when pouring to allow the protruding sealing member 152 to point upwards when dispensing the liquid and thereby to optimally delay the dispensing of the upper-phase 10.

According to some embodiments of the invention, the flow-impeding device 150 may include a multiplicity of reduced openings 151 to create a more symmetrical structure of the reduced openings 151 and of the sealing members 152 so that the pouring rotational angle of the bottle 100 may result in substantially the same effect. Alternatively, if the reduced opening 151 position and/or shape is asymmetric, the user may be required to hold the bottle 100 according to predefined rotation angle(s) that may be marked upon the bottle 100. For example, in the embodiment illustrated in FIG. 6, there is a polar symmetry (the bottom side is a mirror view of the top side of the flow-impeding device 150), therefore the user may be required to hold the bottle 100 in two possible pouring rotation angles.

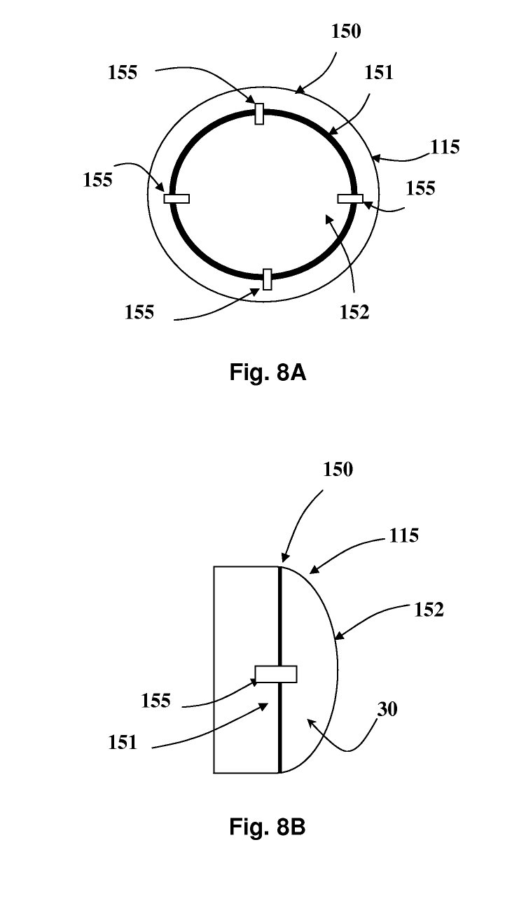

FIG. 8A and FIG. 8B schematically illustrate the flow-impeding device 150 according to additional embodiments of the invention. A protruding circular sealing-member 152 may be seated substantially at the center of the circumference 115 of the bottle's 100 edge. The protruding sealing member 152 may be half a sphere fastened to the circumference 115 of the neck 110 by any securing means 155 known in the art, where the securing means 155 enable separating the protruding sealing member 152 from the circumference 115 of the neck 100 thereby creating reduced openings 151 situated along a ring encircling the protruding sealing member 152.

Once tilted into a pouring position—the upper-phase 10 may reach the cavity 30 inside the protruding sealing-member 152 delaying the dispensing of the upper-phase 10, while the lower part of the ring-like reduced opening 151 enables the lower-phase 20 to exit and the upper part of the reduced opening 151 serves as a hole or holes enabling to slightly enhance the dispensing of the lower-phase 20 liquid.

The bottle 100 may be made of any solid material known in the art or a collection or mixture of several materials such as plastic, glass, metal and the like.

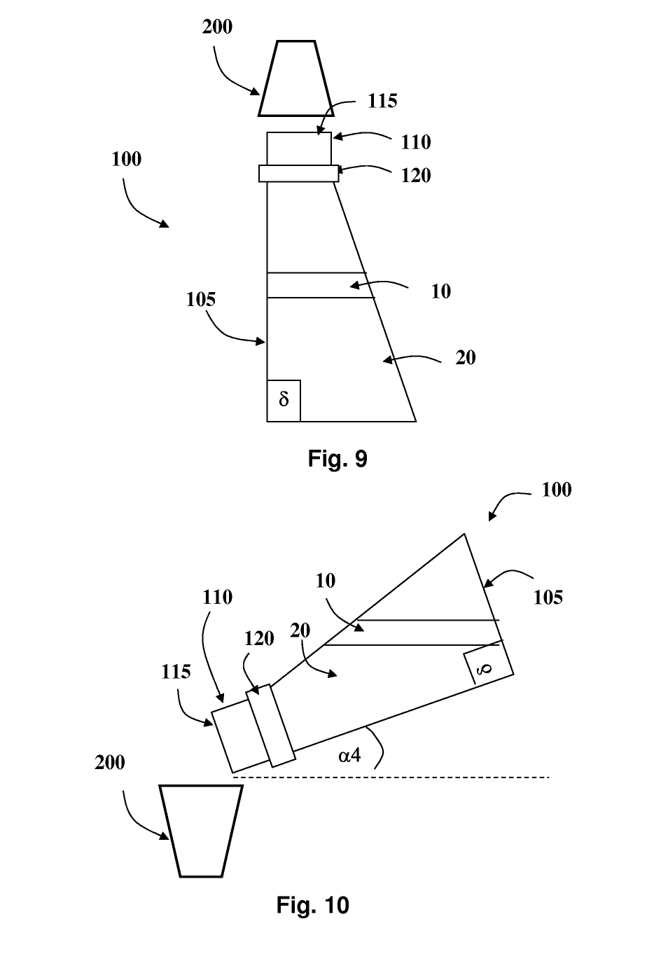

FIG. 9 and FIG. 10 schematically illustrate an alternative bottle 100 shape that may also facilitate in the delaying effect. At least one of the side corners at the lower part of the bottle 100 may be perpendicular to the bottle's 100 base, where the two crossing walls of the body 110 creating the corner are also perpendicular to one another. This right angled corner may enhance the flow of the lower-phase 20 towards the opening of the bottle 100 by leaving less space for the lower-phase 20 to remain in once the liquid is poured with the right-angled corner facing downwards, as illustrated in FIG. 10.

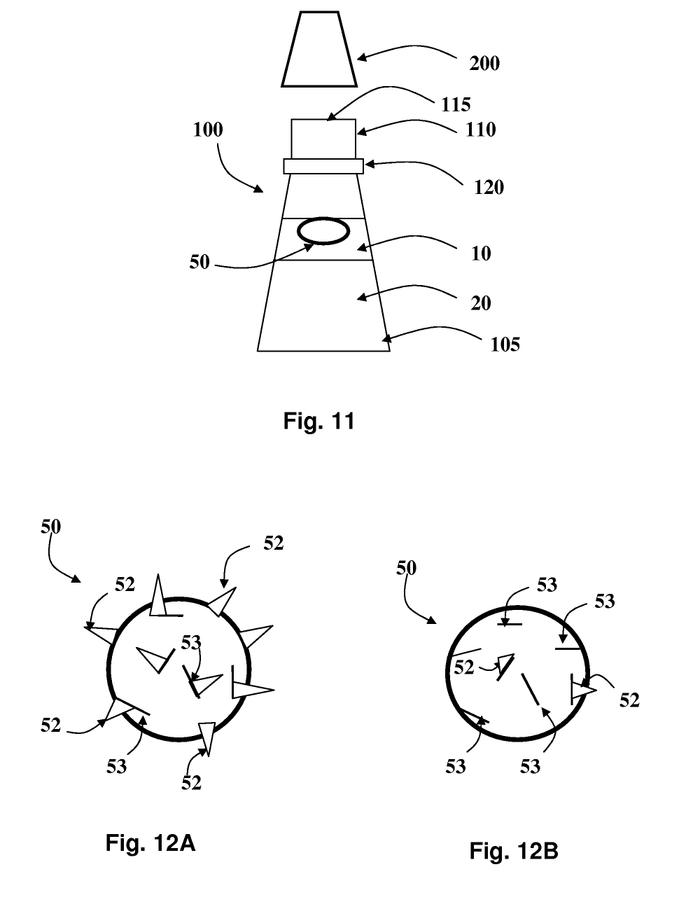

FIG. 11, FIG. 12A and FIG. 12B may schematically illustrate a separate apertures reducer 50, according to alternative embodiments of the invention. According to these embodiments, the separate flow-impeding device 50 may be a separated piece inserted into the bottle 100 in order to enable sealing some of the bottle's 100 opening when the two-phase liquid is poured by enabling to move inside the bottle 100. The separate flow-impeding device 50 may be made of a material that may float above the upper-phase 10 (meaning that the flow-impeding device 50 is of a specific weight that is lower than that of the upper-phase 10), or above the lower-phase 20 between the two phases as illustrated in FIG. 10 (meaning that the flow-impeding device 50 is of a specific weight that is higher than that of the upper-phase 10 and lower than that of the lower-phase 20). The neck 110 opening may enable blocking the flow-impeding device 50 by having a smaller diameter than the diameter of the separate flow-impeding device 50.

To be able to insert the separate flow-impeding device 50 into the bottle 100 the separate flow-impeding device 50 may be retractable enabling to enlarge its dimensions once inserted into the bottle 100. For example, the separate flow-impeding device 50 may be a ball like shape with retractable protrusions 52 inserted into niches 53, where the protrusions 52 can retract to an open protruding position (as illustrated in FIG. 12A). Once the user and/or the manufacturer pushes the separate flow-impeding device 50 into the bottle 100 through the neck 110, the protrusions 52 that are in contact with the neck 110 may be pushed into their niches 53 (as illustrated in FIG. 12B), thereby diminish the flow-impeding device's 50 dimensions allowing it to be inserted into the bottle 100. Once inside the bottle 100, where no substantial strain is applied upon the separate flow-impeding device 50, the retractable protrusions 52 may pop out again and remain in that position while inside the bottle 100. In a retracted position, the separate flow-impeding device 50 may block some of the opening of the neck 110, since it may fall into the bottle 100 opening along with the liquid that is being dispensed and since in a retracted position the separate flow-impeding device 50 is of bigger dimensions than the diameter of the opening it may enable reducing the area of the opening and thereby impeding the dispensing of the upper-phase 10.

Alternatively, the retractable separate flow-impeding device 50 may be made of retractable elastic materials such as rubber or elastic polymers, enabling to change its dimensions by contracting when being squeezed through the neck 110 and retracting once no pressure is applied thereon.

Depending on embodiments of the invention, the bottle 100 may comprise a multiplicity of separate flow-impeding devices 50 of sizes and shapes according to the bottle 100 size, shape and other practical and/or advertising considerations of the manufacturer.

The separate flow-impeding device (s) 50 may additionally facilitate in dispersing of the mixture of phases once the two phases are mixed and thereby facilitate in creating a substantially homogeneous emulsion of the two-phases once the liquid in the bottle 100 is mixed.

According to some embodiments of the invention, the user may be required to mix the phases 10 and 20 (e.g. by shaking the bottle 100) to create the emulsion, and then to pour a portion of the liquid into the cap 200. A new thinner upper-phase 10 may reform again at the upper surface above the emulsion, during the time interval that has passed between the mixing and the pouring, which may be at least partially impeded in the bottle 100 by the flow-impeding device 150.

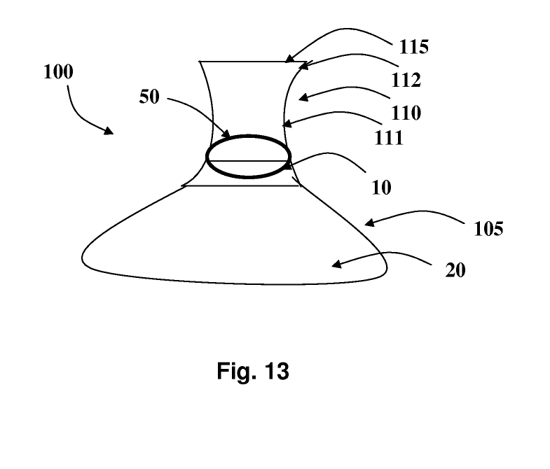

FIG. 13 is a schematic illustration of a side view of a bottle 100 containing a two-phase liquid with a separate flow-impeding device 50, according to other embodiments of the invention. According to these embodiments, the lower part 111 of the neck 110 may be situated between the upper part of the body 105 and the upper part of the neck 112. The encircling walls of the lower part 111 may be narrower (in aperture) than the encircling walls of the upper part 112 of the neck 110 and the upper part of the body 105. The narrower lower part 111 of the neck 110 may enable holding the flow-impeding device 50 therein, preventing the device 50 from either falling into the cavity of the body 105 or exiting the bottle from the opening, when the bottle 100 is tilted into a pouring position.

The separate flow-impeding device 50 may be a rounded device that is retractable enabling to change its size to be inserted into the bottle through the bottle's opening 115 and retracting back into a larger size once inside the narrowed area 400. The walls of the upper part 111 may be narrower than at least one of the diagonals of a cross section area of the flow-impeding device 50. Therefore, once the bottle 100 is tilted into a pouring position, the flow-impeding device 50 is trapped inside the narrow lower part 111 of the neck 110 enabling blocking a part of the bottle's 100 opening and thereby impeding the flow of the dispensed liquid.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A bottle for containing and dispensing of a non-uniform liquid, wherein said bottle comprises a flow-impeding device, wherein said flow-impeding device impedes the flow of the liquid that is dispensed from the bottle to allow impeding the dispensing of the liquid uppermost layer, by reducing the aperture of the bottle's opening.

2. The bottle of claim 1, wherein said non-uniform liquid is a two-phase liquid having a lower-phase liquid and an upper-phase liquid, where the specific weight of the lower-phase liquid is higher than the specific weight of the upper-phase liquid, wherein said upper-phase naturally floats above said lower-phase.

3. The bottle of claim 1 further comprising
a body, which is the lower part of the bottle; and
a neck integrally connected to said body located above the body, wherein the top edge of said neck defines an opening of the bottle having a predefined circumference,
wherein said flow-impeding device is integrally connected to the circumference of the bottle's opening, and
wherein said device comprises at least one protruding sealing member creating at least one reduced opening, wherein said protruding sealing member is a curved structure creating at least one cavity enabling to receive the liquids from within the bottle,
wherein said member enables impeding the dispensing of the uppermost layer when the bottle is positioned in a pouring tilted position by sealing a part of the bottle's opening and by enabling at least part of the uppermost layer to be contained by said cavity.

4. The bottle of claim 3, wherein said impeding is enabled once said at least one protruding sealing member is located above the reduced opening in the pouring position.

5. The bottle of claim 3, wherein said flow-impeding device comprises two protruding sealing members connected to one another to create the reduced opening.

6. The bottle of claim 3, wherein said flow-impeding device comprises two protruding sealing members connected to one another to create the reduced opening.

7. The bottle of claim 6, wherein said two protruding sealing members are connected to one another in a configuration that creates a mouth-shaped reduced opening.

8. The bottle of claim 1 further comprises a cap, which serves as a container for containing of the dispensed liquid and as a lid of the bottle.

9. The bottle of claim 3, wherein at least one of the protruding sealing members comprises at least one hole enabling to enhance the flow rate of the liquid that is dispensed.

10. The bottle of claim 3, wherein at least one of the protruding sealing members comprises at least one indicator thereon, which enables indicating the correct positioning of the sealing member when used for dispensing of said liquid.

11. The bottle of claim 3, wherein said protruding sealing member is rounded and situated at the center of the bottle's opening separated from the circumference of the neck and connected thereto by securing means, creating reduced openings situated along a ring encircling the protruding sealing member.

12. The bottle of claim 1 further comprising a protruding ring, which is a circular protruding structure creating a ring cavity therein, wherein said ring integrally connects the upper edge of the body to the lower edge of the neck.

13. The bottle of claim 1, wherein the non-uniform liquid is a two-phase mouthwash containing substances that can be used for mouthwash, wherein each phase may have a different function in desorbing bacteria in a user's oral tissue.

14. The bottle of claim 3, wherein the body has a trimmed conical shape having a bottom-base which is wider than the top-base, wherein the circumference of the lower edge of the neck is equal to the circumference of the upper edge of the body.

15. The bottle of claim 3, wherein said body includes at least one right-angled corner at the lower part of the bottle, wherein said corner is constructed from two crossing walls of the body and the body's base, where the walls are perpendicular to one another and to the base.

16. The bottle of claim 1, further comprising:
a body, which is the lower part of the bottle;
a neck integrally connected to said body located above the body, wherein the top edge of said neck defines an opening of the bottle having a predefined circumference; and
at least one separate flow-impeding device inserted into said bottle,
wherein said separate flow-impeding device is a piece that is separated from the bottle,
wherein said separate flow-impeding device is of shape and dimensions that enable the neck opening to block the separate flow-impeding device from exiting the bottle, thereby enabling the separate flow-impeding device to reduce the area of the bottle's opening and therefore to facilitate in impeding the dispensing of the upper-phase.

17. The bottle of claim 16, wherein said separate flow-impeding device enables changing of its dimensions to allow contracting when inserted into the bottle through the neck and retracting once inside the bottle.

18. The bottle of claim 17 wherein the lower part of the neck is situated between the upper part of the body and the upper part of the neck, wherein the encircling walls of the lower part are narrower than the encircling walls of the upper part of the neck land the upper part of the body,
Wherein the narrower lower part of the neck enables holding the flow-impeding device therein, preventing the device from either falling into the cavity of the body or exiting the bottle from the opening, when the bottle is tilted in a pouring position,
wherein the walls of the upper part of the neck are narrower than at least one of diagonal of the flow-impeding device, therefore, the narrow upper part enables trapping the flow-impeding device therein to block a part of the bottle's opening and thereby impede the flow of the dispensed liquid.

19. The bottle of claim 17, wherein said separate flow-impeding device is made from elastic materials enabling it to change its dimensions according to pressure applied thereon.

20. The bottle of claim 17, wherein said separate flow-impeding device is round, with retractable protrusions and niches, wherein the protrusions enable entering the niches once pushed through the neck and retracting back to an open protruding position once inside the bottle.

21. The bottle of claim 16, wherein the specific-weight of the flow-impeding device is higher than that of the upper-phase and lower than that of the lower-phase, wherein the separate flow-impeding device floats between the two phases once the bottle opening faces upwards.

22. The bottle of claim 16, wherein the specific-weight of the upper-phase is lower than that of the flow-impeding device, wherein the separate flow-impeding device floats above the upper-phase once the bottle opening faces upwards.

23. A method of dispensing a non-uniform liquid from a bottle containing said liquid, wherein said non-uniform liquid comprises a lower-phase and an upper-phase where the lower-phase is a liquid of a higher specific-weight than the upper-phase, said method comprising:
mixing of the two-phases creating a temporary emulsion; and
pouring a portion of the liquid into a cap,
wherein said flow-impeding device impedes the flow of the liquid that is dispensed from the bottle to allow the dispensing of a reformed upper-phase from said bottle.

24. The method of claim 20 further comprising the step of receiving at least a portion of the reformed upper-phase,
wherein said flow-impeding device comprises at least one protruding sealing member creating at least one reduced opening, wherein said protruding sealing member is a curved structure creating at least one cavity therein enabling to receive the liquids from within the bottle,
wherein said member enables impeding the dispensing of the upper-phase when the bottle is positioned in a pouring tilted position by sealing at least part of the bottle's opening and by enabling at least part of the reformed upper-phase to be contained by said cavity.

25. The method of claim 20, wherein said impeding is carried out by sealing a part of the bottle's opening, wherein said flow-impeding device is a separate piece that is separated from the bottle and is inserted into the bottle,
wherein said separate flow-impeding device enables moving inside the bottle,
wherein the opening of said bottle blocks it from exiting the bottle, thereby enabling the separate flow-impeding device to reduce the area of the bottle's opening and therefore to facilitate in impeding the dispensing of the reformed upper-phase.

26. A bottle for containing and dispensing of a non-uniform liquid comprising a lower-phase and an upper-phase where the lower-phase is a liquid of a higher specific-weight than the upper-phase, wherein said bottle comprises a body, which is the lower part of the bottle; and a neck integrally connected to said body located above the body, wherein the top edge of said neck defines an opening of the bottle
wherein said body includes at least one right angled corner at the lower part of the bottle, wherein said corner is constructed from two crossing walls of the body and a base of the body, wherein the walls are perpendicular to one another and to the base to allow impeding of the dispensing of the top phase by enhancing the flow of the lower-phase towards the opening of the bottle by leaving less space for the lower-phase to remain in, once the liquid is poured with the right-angled corner facing downwards.

27. The bottle of claim 26 wherein said two-phase liquid is a mouthwash containing substances that can be used for mouthwash, wherein each phase may have a different function in desorbing bacteria in a user's oral tissue.

28. A bottle for containing and dispensing of a non-uniform liquid comprising of an upper-phase and a lower-phase, wherein the upper-phase has a lower specific weight than that of the lower-phase, said bottle further comprising at least one separate device that is inserted into said bottle, wherein said device facilitates in dispersing of the two-phases and creating a substantially homogeneous emulsion of the two-phases once the liquid in the bottle is mixed.

29. The bottle of claim 28, wherein said separate device enables changing of its dimensions to allow contracting when inserted into the bottle through the neck and retracting once inside the bottle.

30. The bottle of claim 28, wherein said separate device is made from elastic materials enabling it to change its dimensions according to pressure applied thereon.

31. The bottle of claim 28, wherein said separate device is round, with retractable protrusions and niches, wherein the protrusions are pushed into the niches once the device is pushed through the neck and retract back to an open protruding position once inside the bottle.
